(19) United States
(12) Patent Application Publication
(10) Pub. No.: US 2005/0169544 A1
(43) Pub. Date: Aug. 4, 2005

(54) System and method for encoding and decoding video

(76) Inventor: Adam Leslie Clark, Victoria (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/931,520

(22) Filed: Aug. 31, 2004

Related U.S. Application Data
(63) Continuation-in-part of application No. 10/770,558, filed on Feb. 2, 2004.
(63) Continuation-in-part of application No. 10/771,096, filed on Feb. 2, 2004.
(63) Continuation-in-part of application No. 10/770,432, filed on Feb. 2, 2004.

(51) Int. Cl. G06K 9/36; G06K 9/00

(52) U.S. Cl. 382/236; 382/166

(57) ABSTRACT

Data values are encoded by mapping multi-dimensional parameters of the data values to respective parameters having fewer dimensions and creating a table of encoded data values in which the data values are represented by their respective encoded counterparts and in which redundancies between the encoded data values are reduced; and transmitting the table of encoded data values. Additionally, a set of reference data values may be transmitted for use by a decoder when decoding the table of encoded data values. The data values may be scaled prior to creating the table of encoded data values.

### RELATED APPLICATIONS

The present application is a continuation-in-part of the following co-pending U.S. patent applications, each of which is incorporated herein by reference:
1. application Ser. No. 10/770,558, entitled “System and Method for Encoding and Decoding Video”, filed Feb. 2, 2004;
2. application Ser. No. 10/771,096, entitled System And Method For Transmitting Live Audio/Video Information”, filed Feb. 2, 2004; and
3. application Ser. No. 10/770,432, entitled “Data Encoding Using Multi-dimensional Redundancies”, filed Feb. 2, 2004.

### FIELD OF THE INVENTION

The present invention relates generally to communication systems and, in particular, to a system and method for encoding and decoding video.

### BACKGROUND OF THE INVENTION

Video signals can be digitized, encoded, and subsequently decoded in a manner which significantly decreases the number of bits necessary to represent a decoded reconstructed video without noticeable, or with acceptable, degradation in the reconstructed video. Video coding is an important part of many applications such as digital television transmission, video conferencing, video database, storage, etc.

In video conferencing applications, for example, a video camera is typically used to capture a series of images of a target, such as a meeting participant or a document. The series of images is encoded as a data stream and transmitted over a communications channel to a remote location. For example, the data stream may be transmitted over a phone line, an integrated services digital network (ISDN) line, or the Internet.

In general, connection of a user interface device to the Internet may be made by a variety of communication channels, including twisted pair telephone lines, coaxial cable, and wireless signal communication via local transceivers or orbiting satellites. Most user interface device Internet connections are made by relatively low-bandwidth communication channels, mainly twisted pair telephone lines, due to the existing infrastructure of such telephone lines and the cost of implementing high-bandwidth infrastructure. This constrains the type of information that may be presented to users via the Internet connection, because video transmissions using presently available coding techniques generally require greater bandwidth than twisted pair telephone wires can provide.

The encoding process is typically implemented using a digital video coder/decoder (codec), which divides the images into blocks and compresses the blocks according to a video compression standard, such as the ITU-T H.263 and H.261 standards. In standards of this type, a block may be compressed independent of the previous image or as a difference between the block and part of the previous image. In a typical video conferencing system, the data stream is received at a remote location, where it is decoded into a series of images, which may be viewed at the remote location. Depending on the equipment used, this process typically occurs at a rate of one to thirty frames per second.

One technique widely used in video systems is hybrid video coding. An efficient hybrid video coding system is based on the ITU-T Recommendation H.263. The ITU-T Recommendation H.263 adopts a hybrid scheme of motion-compensated prediction to exploit temporal redundancy and transform coding using the discrete cosine transform (DCT) of the remaining signal to reduce spatial redundancy. Half pixel precision is used for the motion compensation, and variable length coding is used for the symbol representation.

However these techniques still do not provide adequate results for the low-bandwidth connections such as dial-up connections or wireless device networks (e.g., GSM or CDMA) that have data transmissions rates as low as 9.6 kilobits/sec, 14.4 kilobits/sec, 28.8 kilobits/sec, or 56 kilobits/sec. For users at the end of a dial-up connection or wireless network, high quality video takes extraordinary amounts of time to download. Streaming high quality video is nearly impossible, (in terms of acceptable time limits for such actions) and providing live video feeds is very challenging.

### SUMMARY OF THE INVENTION

A method for encoding and decoding video comprises receiving the video as a plurality of pixel value sets, wherein each pixel value set of the plurality of pixel value sets represents a digitized pixel of the video. Data values are encoded by mapping multi-dimensional parameters of the data values to respective parameters having fewer dimensions and creating a table of encoded data values in which the data values are represented by their respective encoded counterparts and in which redundancies between the encoded data values are reduced; and transmitting the table of encoded data values. Along with the table of encoded data values, a set of reference data values may be transmitted for use by a decoder when decoding the table of encoded data values. The data values may be pixels and the reference data values may be reference pixels for a frame of video information. In some embodiments, the data values may be scaled prior to creating the table of encoded data values.

### BRIEF DESCRIPTION OF THE DRAWINGS

The present invention will be understood and appreciated more fully from the following detailed description taken in conjunction with the drawings in which:

FIG. 1 illustrates a block diagram of an exemplary system for compressing video information, according to one embodiment of the present invention;

FIG. 2A illustrates a flow diagram of an exemplary encoding process, according to one embodiment of the present invention;

FIG. 2B illustrates a flow diagram of an exemplary process for determining a set of reference pixels, according to one embodiment of the present invention;

FIG. 2C illustrates a flow diagram of an exemplary process for determining dominant pixel color, according to one embodiment of the present invention;

FIG. 3 illustrates a flow diagram of an exemplary decoding process, according to one embodiment of the present invention;

FIG. 4 illustrates an exemplary network architecture, according to one embodiment of the present invention; and

FIG. 5 illustrates an exemplary computer architecture, according to one embodiment of the present invention.

### DETAILED DESCRIPTION

A system and method for encoding/decoding video data are described. The present encoding/decoding system and method overcome prior deficiencies in this field, by allowing high-quality video transmission over low-bandwidth connections. In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, signals, datum, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

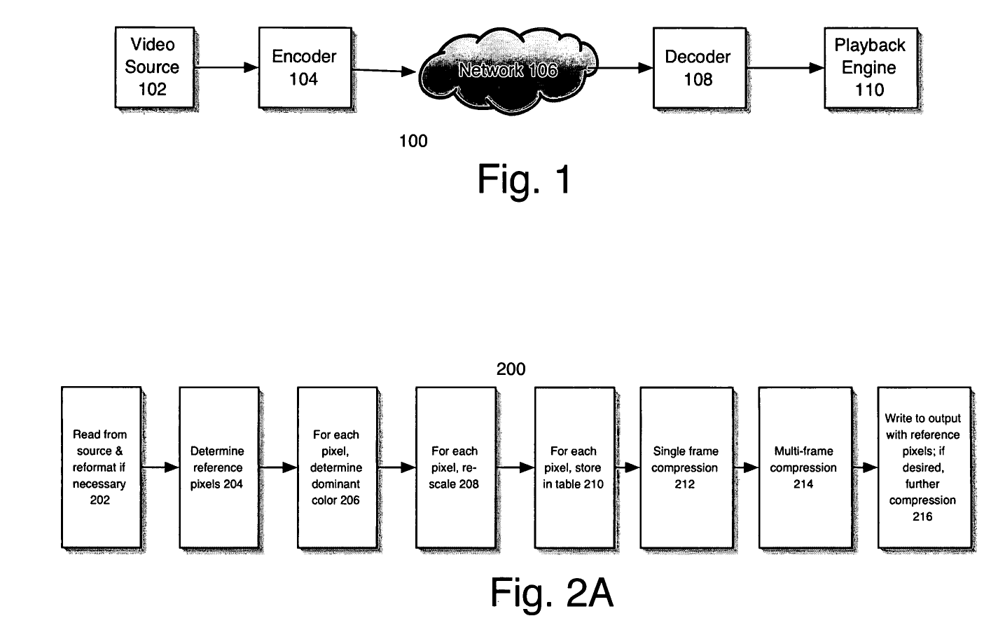

FIG. 1 illustrates an exemplary block diagram of a system 100 for compressing/decompressing video, according to one embodiment of the present invention. System 100 is designed to deliver high quality video over low-bandwidth (e.g., 14.4-56 kbps) transmission links. System 100 may obtain video information from any of a number of sources 102 such as a personal computer, Digital Versatile Disc player, Video Cassette Recorder, storage device, digital video tape camera or player, and/or laser disc player, among others. Live video inputs may also be used, for example from Web cameras or other live video inputs. A digital video capture device receives the video signals from any or all of the sources and converts the video signal into a digital video data file format. The capture device may be any combination of hardware and software video acquisition product, such as Media Compose and Symphony software suites manufactured by Avid Technologies, Black Magic Design by Decklink for use with Apple's Final Cut video editing software, and Canopus video capture devices. Where the source file is already in a digital video file format, the capture process may be omitted. The digital video data may be in any format but is preferably not in a compressed format. The remainder of the discussion will assume that the video file is in an uncompressed format. If this is not the case, it may be necessary to decompress the file before proceeding with the process described below.

Generally, audio signals may accompany the video signals from the source devices. The audio signals are digitized (if necessary) and provided along with the video data in a two-channel, 22 kHz uncompressed format, in one embodiment. The audio data may be processed independently of the video data, using any conventional audio compression method. Such audio may be synchronized with the video data file at any point within system 100 and because these synchronization processes are well known in the art they will not be discussed further herein.

Included with the video data may be certain meta data, for example in the form of a header. The header may be appended to the video data and may include various information regarding the audio data (if any) and video data, such as file sizes (e.g., in bytes), video frame starting and ending points, tags at certain video frame intervals (e.g., every tenth frame), the number of video frames per second, total number of frames, the screen resolution (i.e., the number of pixels per frame), color depth information, and similar types of data regarding the files.

System 100 uses an encoder 104 to compress the input video data and produce a compressed video file. The compressed video file may include meta data, e.g., in the form of header information including resolution settings for the decoder, audio/video synch information, playback commands, reference pixel values, and optional information, such as a key frame indicator used for trick play modes. The majority of the compressed video file is a table (or tables) of pixel value sets for each frame in the video file. Encoder 104 may also generate optional files, such as a trailer file (used with AVS tools). Encoder 104 also produces an audio output file that may or may not be compressed. For purposes of this specification reference to the compressed video file includes any audio files, optional files and/or header information. The details of the encoding process performed by encoder 104 will be discussed below.

The compressed video file may be transmitted over a network 106 (which is described in greater detail below) to a decoder 108. The transmission process itself may involve further compression operations. For example, the compressed file may be subjected to compression using conventional encoding schemes such as run length encoding or other encoding methods and procedures to further reduce the size of the compressed video file prior to transmission. This is especially useful where transmission is to occur over low bandwidth communication links. This further compressing of the compressed video file may take place at a server used for storing and forwarding the compressed video file.

Decoder 108 decodes the compressed video file and provides decoded video to playback engine 110. Additionally, audio information may be synchronized with the decoded video file, and provided to playback engine 110. The process performed by decoder 108 will be described in detail below. Playback engine 110 may include a display device adapted to accept video data. In addition, the playback engine may include conventional means for transforming the decoded video file to a format compatible with conventional display devices. Any display device such as a television, cellular phone, personal computer, personal data assistant (PDA), automobile navigation system, or similar device may be used. Having provided a high level overview of system 100, a detailed description of its components will be presented.

### An Exemplary Encoding Process

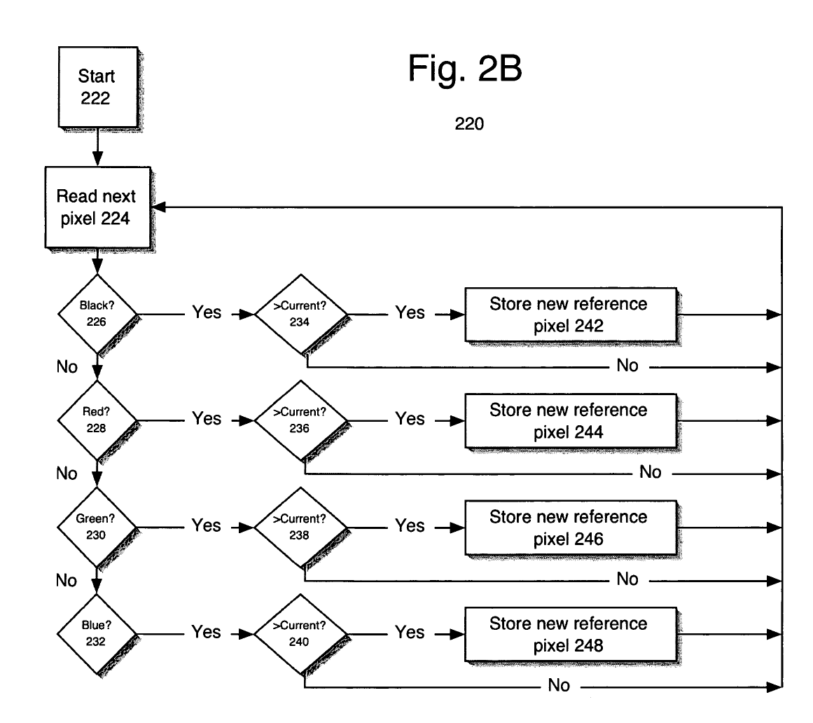

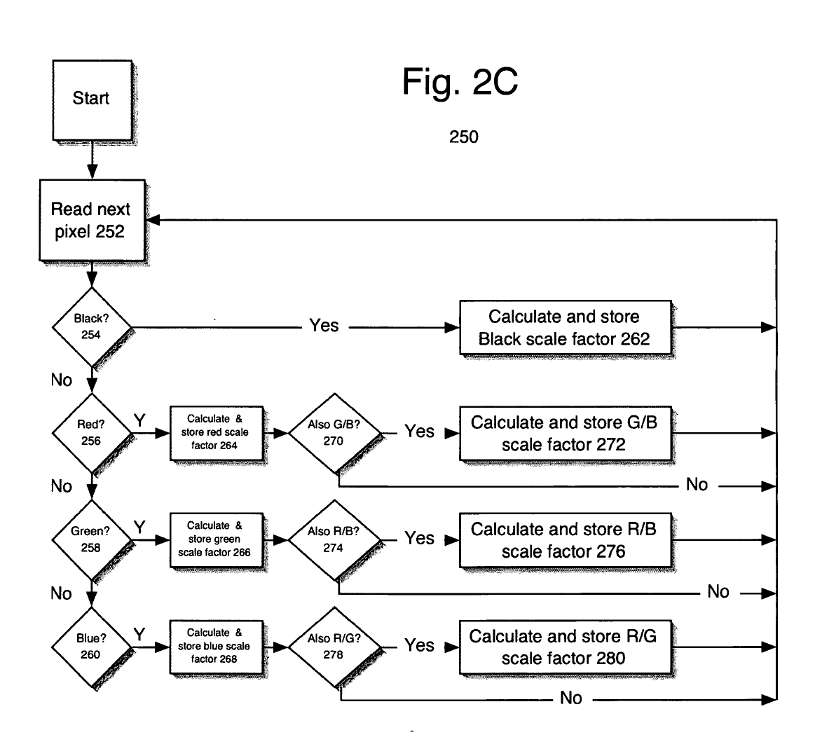

FIG. 2A illustrates a flow diagram of an exemplary encoding process 200, according to one embodiment of the present invention. As discussed above, encoder 104 receives video data, compresses and encodes it, and then provides a compressed video file, including pixel references values, compressed video tables, and any additional parameters and optional information desired. The input video sequence is typically composed of thousands of pixels grouped into individual frames. The exact number of pixels in a frame depends upon the video format. The present methods and systems support a variety of input video formats, including but not limited to the National TV Standards Committee (NTSC) video format having 30 interlaced frames per second at 525 lines of resolution, the Phase Alternating Line (PAL) format having 25 interlaced frames per second at 625 lines of resolution, the System en coleur avec memoire (SECAM) format and various worldwide formats for Digital High Definition Television (HDTV). Additionally, video formats designed for display on personal computers, cellular phones, and PDAs are supported.

Depending on the type of digital video capture device or source used, the input video file will generally include a number of tables (or other data structures) organized to represent the pixel information for each frame. In the following discussion it is assumed that the input file represents pixels in term of their red-green-blue (RGB) color components, however, this is not critical to the present invention. In alternate embodiments, any color space may be used such as cyan, magenta, yellow, and black (CMYK). Luminance and chrominance information for the pixels may be provided in addition to or in lieu of the color information. Again, these distinctions are not critical to the present invention and the present methods may be adapted for use with any of these formats for representing pixel information.

In addition to color (or other) information, the input file will include information regarding pixel location within a frame. This location information is retained (either directly or through an appropriate mapping) during the present compression process so that the pixel can be reproduced at the appropriate location within its corresponding frame by the decoder for eventual playback.

At step 202, encoder 104 reads the video file provided by the video source or the video capture device, along with any metadata provided with the input video file to allow encoder 104 to determine the resolution of each frame. If necessary, the video file may be reformatted to a raw data format (e.g., if the file had been previously compressed) or other preferred format. Alternatively or in addition, the frames may be resized, for example to a lower resolution if playback is to occur over a different screen size or shape than was originally intended for the video file. For example, a video file originally intended for playback over a television at conventional PAL resolution (768×576 pixels) may be resized (e.g., to 384×288 pixels) for playback over a smaller display (e.g., as might be found on a conventional PDA).

At step 204, encoder 104 determines for each frame in the video file a set of reference pixels for the frame. An example of the manner in which this is done is illustrated in process 220 shown in FIG. 2B.

At the outset (step 222), it should be noted that the process iterates (step 224) until all pixels in a given frame have been examined. For each pixel, a determination is made as to whether the pixel is a Black, Red, Green or Blue pixel (steps 226, 228, 230 and 232, respectively). In one embodiment, the pixel's color parameters (e.g., its RGB values) are examined against thresholds to determine if the pixel should be categorized as one of these colors. For example, if the maximum value for a color parameter is 1000, then a threshold may be set such that all three R, G and B values must be greater than or equal to 800 to be a black pixel. The black reference pixel is the pixel in the frame having the highest intensity R, G, and B values. For example, a pixel of a raw video frame having R, G, and B values of “999”, “999”, and “999” (where R, G, and B are each represented on a scale of 0-1000) is likely to end up becoming the black reference pixel for the frame of interest. Otherwise, the pixel's dominant color is the color represented by the higher of the three remaining color values.

Once the pixel's color is determined, a decision is made as to whether that pixel should be saved as the reference pixel for that color (steps 234, 236, 238, 240, for Black, Red, Green and Blue, respectively). That is, the color parameter values of the pixel under examination are compared against previously stored values of a current reference pixel for the color of interest. If the new pixel has a higher color parameter for the color of interest than the current reference pixel for that color, the new pixel replaces the current pixel as the reference pixel for that color (steps 242, 244, 246 and 248 for Black, Red, Green and Blue, respectively). Otherwise, the current reference pixel for the color is retained as the reference pixel. Ultimately, this process 220 will result in the highest intensity pixels for each color being stored as the reference pixels for the frame.

It should be noted that all of the color information for each reference pixel is stored. For example, in the case of the RGB color space, the entire RGB triplet value is stored for each reference pixel. Optionally, all of the other pixel parameters may also be stored for each reference pixel. Although in one embodiment of the present invention the reference pixels are determined before any further processing of a frame of the input video file, in some cases the determination may be made at the same time or substantially the same time as the dominant color of each pixel is determined. As further discussed below, the determination of a pixel's dominant color allows pixels to be grouped according to color. Note that it is not necessary for the encoder 104 to determine all of the reference pixels for all of the frames of the input video file before any further processing is performed. Instead, frames are preferably processed on a frame-by-frame basis such that after the reference pixels for a particular frame are determined, that frame is encoded with respect to those reference pixels so determined.

Returning now to FIG. 2, in a presently preferred embodiment, once a frame's reference pixels have been determined (step 204), the dominant color of each pixel in that frame is determined (step 206). In some embodiments, steps 206 and 208 may be performed in combination on a pixel-by-pixel basis. One example of the manner in which each pixel's dominant color is determined is discussed with reference to FIG. 2C, which illustrates a process 250 for determining a pixel's dominant color according to one embodiment of the present invention.

Process 250 iterates (step 252) until each pixel of a frame has been coded to its dominant color (or colors). Initially, each pixel is examined (steps 254, 256, 258 and 260) to determine if the pixel is mostly Black, Red, Green or Blue. A pixel is determined to be Black if all of the red, green and blue color values for that pixel are above a certain threshold. Otherwise, the dominant color is the color represented by the highest of the three remaining color values. The pixels are then compared to their corresponding reference pixels (e.g., a red pixel to the red reference pixel, a blue pixel to the blue reference pixel, and so on) and the scale factor for the pixel under consideration is determined (steps 262, 264, 266 and 268, for Black, Red, Green and Blue, respectively). Scaling may be done on an absolute basis (e.g., considering the full range of possible values for a given color of a pixel) or a relative basis (where the reference pixel value is considered as full scale). Once this scaling is complete (step 208 in FIG. 2), the process may quite and go on to the next pixel.

In other cases, however, the process may continue to determine whether or not the pixel of interest has two dominant colors. Note this applied only to non-Black pixels. For a Red pixel, at step 270 a decision may be made to determine if the pixel should also be considered green or blue (i.e., is the pixel Red/Green or Red/Blue). This decision can be based on a determination of whether or not the value of the Green or Blue color component is above a certain threshold. If so, the Green/Blue scale factor may likewise be associated with the pixel (step 272) in same manner as the Red scale factor was. Similar procedures (steps 274 & 276, or 278 & 280) may be used for Green/Red, Green/Blue, Blue/Red and Blue/Green pixels. A Red/Green/Blue pixel is of course considered a Black pixel. This procedure may repeat until encoder 104 has encoded all of the pixels of a frame.

Returning to FIG. 2 then, each pixel is sorted into an appropriate color group (e.g., red, green, blue or black) according to the dominant color (or colors) of that pixel and the color values scaled. It is important to recognize that the process of sorting a pixel into its color group (e.g., by determining its dominant color(s)) reduces the amount of color information associated with the pixel. Rather than an RGB triplet, for example, the pixel will have only an associated color group indicator (R, G, B or Black, or perhaps a two-color indicator) and an associated scale factor (e.g., as compared to the appropriate reference pixel). Essentially, the pixel's color information (or luminance/chrominance information, and so on) has been mapped to a reduced data set.

During the scaling, any appropriate scale factor may be used. For example, if a pixel has been determined to belong to the red pixel group, and its color parameters are to be rescaled according to the red reference pixel, although the original video file may have had a color parameter scale of, say, 0-999, in order to reduce the volume of data needed to describe the video file this scale may be adjusted to, say, 0-8. Because the red reference pixel is the most intense red pixel in the frame, it is assigned a red=8 color parameter (note, this is merely an example and any convenient scale may be used). The pixel of interest is then scaled on this 0-8 scale according to the ratio of its original red color parameter value to that of the red reference pixel. Once each pixel has been categorized by its dominant color and scaled in accordance therewith, it may be quantized and stored in a table (step 210).

In an alternative embodiment, rather than determining individual reference pixels for each frame, the encoded may be configured with a predefined color pallet. In such an implementation, each pixel of the incoming frame may be compared to the encoder color pallet and coded to correspond to the closest matching color of the color pallet. If the decoder is provided with a similar color pallet, then the frame may be reconstructed by substituting the pixel colors of the decoder color pallet for the encoded values received from the encoder. Such a scheme may be advantageous where the number of bits required to represent the encoded colors are fewer than those needed to represented the unencoded colors. This may be accomplished by sizing the color pallet (i.e., limiting the number of available colors) appropriately. Different color pallets may be stored in a single encoder/decoder combination and selected (automatically or at user command) according to factors such as the color fidelity desired, the available bandwidth for storage/transmission and/or other factors. In some cases, where the decoder does not have the color pallet pre-stored, the color pallet may be transmitted ahead of the encoded video.

Steps 204-210 thus represent a process (which may iterate on a frame-by-frame basis) for populating one or more tables, where each table includes pixel information for a frame of the original video file (of course in other embodiments some number of frames or even the entire video sequence may be allocated to a single table). Where used, the reference pixels or an indication of the encoder color pallet used may also be so allocated. Where the decoder does not have a copy of the appropriate color pallet, that pallet may be included. These newly created table or tables may undergo so-called “single frame compression” (assuming each frame has a corresponding unique table) at step 212. Alternatively, this compression may be performed while a table of scaled pixel values is being generated.

This single frame compression process groups pixels having the same or similar enough (e.g., within a tolerance range) scaled parameter values so as to reduce the total number of bits required to describe a run of adjacent pixels. For example, if a frame were encoded such that its corresponding table produced at step 210 contained a run of 100 black pixels adjacent to one another (e.g., across one or more lines of the frame), then rather than have 100 separate entries in the table to represent those pixels a single entry setting forth the pixel parameters and an indication that it should repeat for 100 pixels upon decoding is entered. Although one embodiment of the present invention treats each pixel uniquely (meaning that in order for pixels to be grouped into runs they must have identical tabulated parameters), in some cases if an anomalous pixel appears in a large field of pixels having the same parameter values, encoder 104 may ignore the anomalies and encode that pixel as if it were another of the pixels having similar parameter values. Of course, this technique should not be applied for images/frames where such anomalies may be important to accurate reproduction of the intended image. In one embodiment, before deciding to ignore such anomalies, the encoder 104 may examine a group of neighboring pixels to the pixel under consideration (e.g., in an n×n grid surrounding the pixel of interest) and decide to so ignore the anomalies only if all of the neighboring pixels would be included in the same run.

In addition to encoding runs of adjacent pixels in this manner, the single frame compression process 212 may optionally encode disconnected runs of pixels as well. That is, if a run of say similar red pixels is encoded at a location corresponding to an upper right half of a frame and a similar run of red pixels having similar parameter values is located at a lower left corner of the frame, rather than re-encoding the same information the single frame compression process 212 may simply insert a table pointer or other reference to indicate that the first run should be replicated at the new location during decoding. Such processes may be used wherever convenient to reduce the overall amount of data required to identify the pixels in the frame of interest and may be modified so as to account for differences in pixel colors, etc.

This single frame compression process 212 may be regarded as removing redundancies within a table of encoded pixel values for a single frame. A similar process may be used to provide compression across multiple frames (e.g., groups of three to five frames) and is provided at optional compression step 214. Of course, where the source is a single frame such a step will be unnecessary.

The multiple frame compression process 214 may be applied across blocks of any number of frames, but in one embodiment is used with blocks of three to five consecutive frames. The first frame in the block is considered a key frame and is encoded in the manner discussed above. Then, the key frame is compared (on a pixel-by-pixel basis) to each of the next two to four frames in the sequence and the differences between the key frame and each successive frame noted. When the number of differences reaches a threshold value (or the frame block limit, e.g., five frames, is reached) a decision is made to identify the frame under comparison as a next key frame. In some cases a frame may be characterized as a key frame where it is more efficient to do so (and encode the entire frame) rather than to compute differences from a preceding key frame.

Having thus identified the next key frame, inter-frame differences between the frames of each block may be encoded. That is, rather than re-encoding pixel runs that are the same (or similar within a tolerance range) as those already encoded for the key frame, the table of encoded pixel values for a non-key frame of a block may simply be augmented to indicate that those same runs should be replicated. Where applicable, frame boundaries may also be indicated within the table of encoded pixel values. Generally, each frame may include its own set of reference pixels or the key frame's reference pixels may be used for all frames of a block. In some embodiments, it may be easier to encode differences between reference pixels rather than entire reference pixel sets for each frame of a block. Also, in some embodiments a predefined color pallet rather than sets of reference pixels may be used. Note that differences between frames (inter-frame differences) may be computed each with respect to the key frame or each with respect to the immediately preceding frame in the block of frames.

Finally, the output of the multi-frame compression process (or, if it is not used, the single frame compression process) is stored as an output table of compressed pixel values (step 216). This table may be combined with other similar tables and stored for later transmission, or it may be transmitted to the decoder 108 immediately. In some embodiments, further compression may be achieved by eliminating redundancies between these tables prior to or during transmission. For example, the run encoding may be maximized across blocks of single frame compressed tables or multi-frame compressed tables. Alternatively, or in addition, inter-key frame redundancies may be reduced or eliminated. Conventional data encoding techniques such as conventional run length encoding (wherein the data values are treated as individual bits and not data words) may also be applied.

Moreover, the encoding process described above may be modified in any of several ways. For example, frames may be divided into other fractional units for determining reference pixels and/or encoding. Audio data may accompany the compressed video data with or without compression. Additional embodiments allow for encoding of pixels from top left of frame to bottom right of frame, as well as other encoding sequences. In additional embodiments, encoder 104 only encodes odd or even rows of pixels, or every other pixel of a frame in order to save bandwidth. Additionally, encoder 104 may encode video originally provided for one protocol and translate it to another protocol. For example, a source video captured from an NTSC source can be encoded and formatted for transmission on a PAL display system by using appropriate pixel interpolation or reduction.

Returning now to FIG. 1, upon processing by encoder 104, the resulting compressed video file may be transmitted over a network 106 to a decoder 108. As indicated above, prior to transmission the compressed video file may be subjected to further compression (e.g., using run length encoding or another encoding process) to reduce redundancies in the data set prior to transmission. Preferably, though not necessarily, this further encoding is a lossless process, though in some applications a lossy process may be used. The further encoding may be performed at a server or other computer resource prior to transmission or even at a point between the encoder and decoder subsequent to transmission over some but not all of the network 106. Note that the further compressed file need not be transmitted but instead may simply be stored for local playback through an appropriate decoder.

### An Exemplary Decoding Process

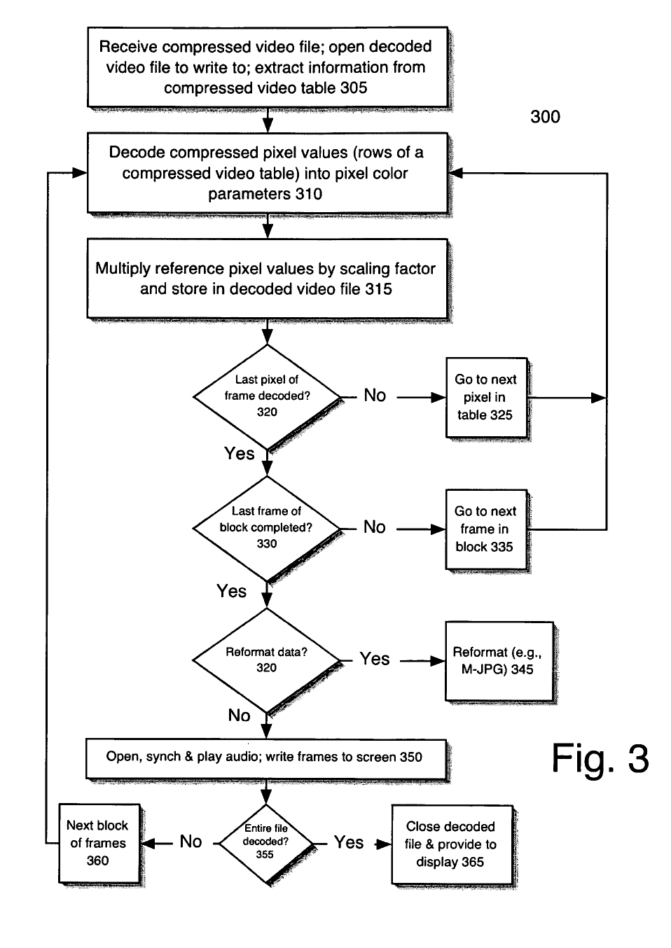

FIG. 3 illustrates a flow diagram of an exemplary decoding process, according to one embodiment of the present invention. As discussed above, decoder 108 receives the compressed video file, decodes and decompresses it, and provides the decoded video file to a playback engine 110. Decoding process 300 generates decoded video as follows. In general, the decoding operations may be used for real-time (or near real-time) encoding/decoding operations (e.g., for live video) or for encoding, storing and later decoding the video.

Decoder 108 receives a compressed video file and extracts header data, reference pixel information, audio data and compressed video data tables for a number of frames (block 305). In one embodiment, blocks of five (5) frames are decoded and the results passed to playback engine 110. In alternate embodiments other variable block sizes of frame lengths may be used, according to the specific application. In still other embodiments, a file may be fully decoded before playback begins. Additionally, header data may only be transmitted with the first block of frames or even just the first frame. The header data may include the overall file size, audio information, video format, file system O/S, frame rate, video format ratio, number of frames and video length.

In some embodiments, a dithering process may be used during reconstruction of the video information so as to increase the color fidelity in the decoded video file. This may be implemented, for example, by modifying the color parameter information of each pixel by, say, up to 10% (e.g., on a pseudorandom basis). This dithering may be performed as the pixels are recreated based on the scaled color information and the corresponding reference pixel and performed in such a fashion so as to “blend” adjacent pixels or runs of pixels and thereby avoid sharp boundaries. Of course in applications where such boundaries are desired this technique may not be appropriate.

Decoder 108 recreates each pixel by examining its dominant color value (R, G, B, or Black) and choosing the corresponding reference pixel (block 310). The reference pixel color parameters are then rescaled according to the scaled color value of the pixel under examination. In one embodiment, not only is the dominant color component rescaled, but even the non-dominant color components are scaled up using the reference pixel color parameter values. The resulting rescaled pixel color parameters are stored in decoded video table (block 315). As an example, for a “red” pixel having a scaled color value of 6, if the corresponding reference pixel had an RGB triplet of 625, 350, 205 for its respective RGB values, then the reconstituted red pixel's color parameters will be 375, 225, and 123, respectively (red value=0.6×625=375; green value=0.6×350=225; blue value=0.6×205=123). In another embodiment, only the dominant color is scaled, therefore, the red pixel described above would have R. G, and B values of 375, 350 and 205, respectively. Other pixel parameters (if any) may be reconstituted in a similar fashion and stored in the decoded video data table.

In alternate embodiments, scaled values, such as scaled color values, scaled luminance values, and/or scaled chrominance values are rescaled relative to a maximum possible value, rather than to a reference pixel value. In such cases, it may not be necessary to compute and transmit the reference pixels. Additional embodiments allow some scaled values to be rescaled relative to reference values and other scaled values are rescaled relative to maximum possible values.

Decoder 108 determines if the last pixel of the frame is decoded (decision block 320). If not, the next pixel in the frame is indexed (block 325) and decoded (blocks 310 and 315). If the end of a frame is reached, decoder 108 determines if it has completed decoding the entire block of frames (decision block 330). If the last frame in the block has not been decoded, the next frame in the block is indexed (block 335) and the frame's pixels are decoded according to blocks 310-325 with its respective reference pixels. If the last frame in the block has been decoded, decoder 108 determines if the frame should be reformatted according to a particular playback protocol, such as motion JPEG (decision block 340). If necessary, reformatting is performed (block 345). Note, the reformatting may be performed by the playback engine rather than the decoder. If no reformatting is necessary or if reformatting is complete, audio data is synchronized with the decoded video (block 350).

Decoder 108 determines if the last frame of the last block of frames has been decoded (decision block 355). If decoding is complete, a decoded video file is closed and provided to playback engine 110 (block 365). If decoding is not complete (block 360), the next block of video frames are indexed and decoded according to blocks 310-365.

In alternate embodiments, frames are decoded successively, without the use of blocks. The decoded video file may be streamed to playback engine 110 while decoder 108 is still decoding the compressed file. Yet in another embodiment decoder 108 takes the form of a look-up table having every possible combination of color code, luminance, and chrominance values listed for immediate mapping. Alternatively, the look-up table (which may be regarded as a color pallet) may have a limited set of color combinations or codes. Luminance and chrominance information may be sent to the decoder (e.g., where needed) in separate tables. In additional embodiments, decoder 108 only decodes odd or even rows of pixels, or every other pixel in order to save bandwidth. Additionally, decoder 108 may decode video originally provided for one protocol and translate it to another protocol. For example, a source video captured from an NTSC source can be decoded and formatted for transmission on a PAL display system. Additional embodiments allow for decoding of pixels from bottom right to top left, as well as other decoding sequences. In one embodiment, the decoder may read a trailer appended to the communicated file. The trailer may provide the decoder with audio/visual information, such as the number of frames and or files remaining in the encoded video, index information to the next file, or other audio/video information related to playback.

The decoded video file can be formatted for displays supporting different input protocols. Such protocols include NTSC, SECAM, PAL and HDTV, as described above. Additionally, support for computer displays is provided. If a low bandwidth network 106 exists between encoder 104 and decoder 108, encoder 104 may perform additional bandwidth saving functions. For example, a lower resolution version of the video may be encoded, or video fields may be dropped by only encoding odd or even rows, or encoding alternate pixels, or reducing screen resolution prior to transmission over network 106. In another embodiment, frames may be dropped prior to transmission. For example, a file encoded at 24 frames per second may be reduced to 12 frames per second by dropping ever other frame prior to transmission. If a low bandwidth communication link exists between playback engine 110 and decoder 108, decoder 108 may be configured to transmit a fraction of the lines per frame, according to one embodiment. These embodiments may be particularly useful when the playback engine 110 is a cellular telephone or other wireless device, requiring high quality video over low bandwidth networks such as GSM, CDMA, and TDMA. In alternate embodiments, when encoder 104 encodes a fraction of the lines per frame, it results in a smaller compressed file transmitted over network 106, and less data decoded by decoder 108 for faster performance. Having discussed numerous illustrations of encoding and decoding functions according to the present method and system, a brief description of the communication network encompassing the present system is provided.

### An Exemplary Network Architecture

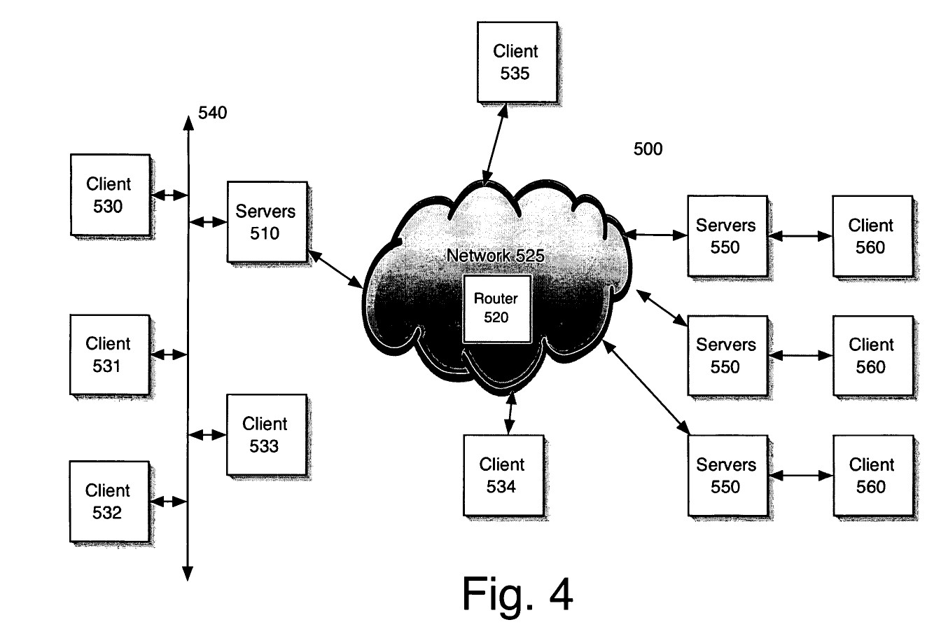

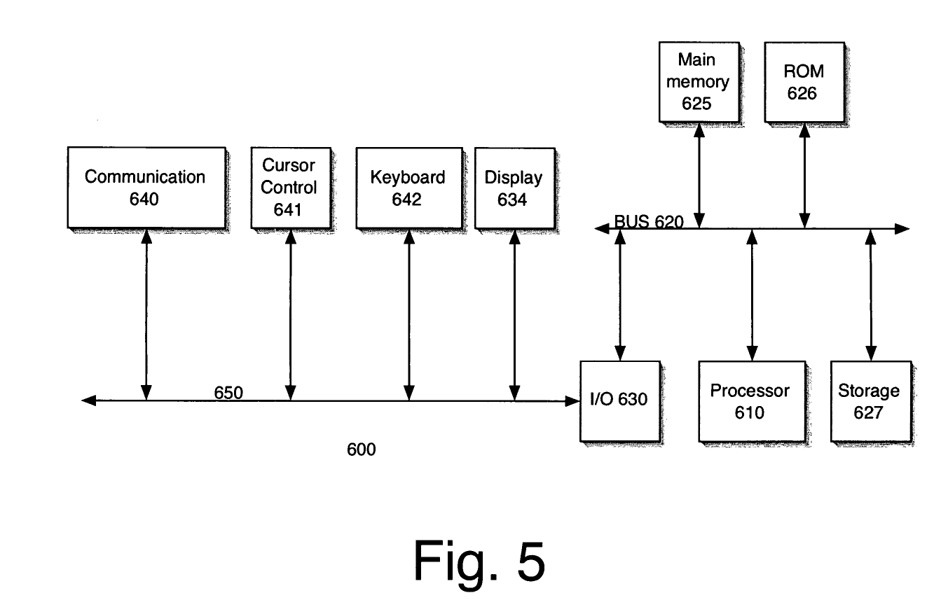

Elements of the present invention may be included within a client-server based system 500 such as that illustrated in FIG. 4. According to the embodiment depicted in FIG. 4, one or more servers 510 communicate with a plurality of clients 530-535. The clients 530-535 may transmit and receive data from servers 510 over a variety of communication media including (but not limited to) a local area network (“LAN”) 540 and/or a wide area network (“WAN”) 525 (e.g., the Internet). Alternative communication channels such as wireless communication via GSM, TDMA, CDMA or satellite broadcast (not shown) are also contemplated within the scope of the present invention. Network 106 illustrated in FIG. 1, may be a local area network, such as LAN 540 or a wide are network, such as WAN 525.

Servers 510 may include a database for storing various types of data. This may include, for example, specific client data (e.g., user account information and user preferences) and/or more general data. The database on servers 510 in one embodiment runs an instance of a Relational Database Management System (RDBMS), such as Microsoft™ SQL-Server, Oracle™ or the like. A user/client may interact with and receive feedback from servers 510 using various different communication devices and/or protocols. According to one embodiment, a user connects to servers 510 via client software. The client software may include a browser application such as Netscape Navigator™ or Microsoft Internet Explorer™ on the user's personal computer, which communicates to servers 510 via the Hypertext Transfer Protocol (hereinafter “HTTP”). Among other embodiments, software such as Microsoft's Word, Power Point, or other applications for composing and presentations may be configured as client decoder/player. In other embodiments included within the scope of the invention, clients may communicate with servers 510 via cellular phones and pagers (e.g., in which the necessary transaction software is electronic in a microchip), handheld computing devices, and/or touch-tone telephones (or video phones).

Servers 510 may also communicate over a larger network (e.g., network 525) with other servers 550-552. This may include, for example, servers maintained by businesses to host their Web sites—e.g., content servers such as “yahoo.com.” Network 525 may include router 520. Router 520 forwards data packets from one local area network (LAN) or wide area network (WAN) to another. Based on routing tables and routing protocols, router 520 reads the network address in each IP packet and makes a decision on how to send if based on the most expedient route. Router 520 works at layer 3 in the protocol stack. According to one embodiment, the compressed video file is transmitted over network 106 as a series of IP packets.

According to one embodiment of the present method and system, components illustrated in FIG. 1 may be distributed throughout network 500. For example, video sources may be connected to any client 530-535 or 560-562, or severs 510, 550-552. A digital video capture device, encoder 104, decoder 108 and playback engine 110, may reside in any client or server, as well. Similarly, all or some of the components of FIG. 1, may be fully contained within a signal server, or client.

In one embodiment, servers 550-552 host a video capture device and encoder 104. Video sources connected to clients 560-562 provide source video to servers 550-552. Servers 550-552 encode and compress the source video and store the compressed video file in databases, as described above. A client 530-532, may request the compressed video file. Servers 550-552 transmit the compressed video file over network 106 to the client 530-533 via server 510. Server 510 may send the compressed video file in blocks of frames. Such compressed files may be further reduced in size prior to transmission, for example using run length encoding or another form of lossless or even lossy encoding. This further compression will be reversed at the receive side. In addition, server 510 and the client 530-533 may be connected via a dial-up connection having bandwidths between 14.4 kBps and 56 kBps. Clients 530-533 include decoder 108, and upon receiving the compressed video file, decode the file and provide the decoded video file to an attached playback engine. One of ordinary skill would realize that numerous combinations may exist for placement of encoder 104 and decoder 108. Similarly, encoder 104 and decoder 108 may exist in the form of software executed by a general purpose processor, or as a dedicated video processor included on an add-on card to a personal computer, a PCMCIA card, or similar device. Additionally, decoder 108 may reside as a software program running independently, or decoder 108 may exist as a plug-in to a web browser. Decoder 108 may be configured to format its video output to have compatibility with existing video devices that support motion JPEG, MPEG, MPEG-2, MPEG-4 and/or JVT standards.

### An Exemplary Computer Architecture

Having briefly described an exemplary network architecture which employs various elements of the present invention, a computer system 600 representing exemplary clients 530-535 and/or servers (e.g., servers 510), in which elements of the present invention may be implemented will now be described with reference to FIG. 5.

One embodiment of computer system 600 comprises a system bus 620 for communicating information, and a processor 610 coupled to bus 620 for processing information. Computer system 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 610. Computer system 600 also may include a read only memory (ROM) and/or other static storage device 626 coupled to bus 620 for storing static information and instructions used by processor 610.

A data storage device 627 such as a magnetic disk or optical disc and its corresponding drive may also be coupled to computer system 600 for storing information and instructions. Computer system 600 can also be coupled to a second I/O bus 650 via an I/O interface 630. Multiple I/O devices may be coupled to I/O bus 650, including a display device 643, an input device (e.g., an alphanumeric input device 642 and/or a cursor control device 641). For example, video news clips and related information may be presented to the user on the display device 643.

The communication device 640 is for accessing other computers (servers or clients) via a network 525, 540. The communication device 640 may comprise a modem, a network interface card, or other well-known interface device, such as those used for coupling to Ethernet, token ring, or other types of networks.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

A system and method for encoding and decoding video have been described. It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising encoding data values by mapping multi-dimensional parameters of the data values to respective parameters having fewer dimensions and creating a table of encoded data values in which the data values are represented by their respective encoded counterparts and in which redundancies between the encoded data values are reduced; and transmitting the table of encoded data values.

2. The method of claim 1, further comprising transmitting along with the table of encoded data values a set of reference data values for use by a decoder when decoding the table of encoded data values.

3. The method of claim 2, wherein the data values comprise pixels.

4. The method of claim 3, wherein the reference data values comprise reference pixels for a frame of video information.

5. The method of claim 1, further comprising scaling one or more of the data values prior to creating the table of encoded data values.

6. The method of claim 1, wherein the data values comprise pixels and the mapping is performed by comparing each pixel to a reference color pallet and selecting a closest matching encoded color value therefrom.

7. The method of claim 6, further comprising transmitting the reference color pallet along with the table of encoded data values for use by a decoder when decoding the table of encoded data values.

8. The method of claim 6, further comprising transmitting an indication of the reference color pallet used during the mapping along with the table of encoded data values for use by a decoder when decoding the table of encoded data values.

9. A method, comprising encoding a digital video file by reducing color fidelity of each pixel of each frame of the digital video file using a set of reference pixels for each such frame; and reducing intra-frame redundancies between such pixels having reduced color fidelity.

10. The method of claim 9, further comprising reducing inter-frame redundancies between groups of frames of the digital video file.

11. The method of claim 10, wherein the intra-frame redundancies are reduced by encoding runs of similar pixels having reduced color fidelity so as to reduce a number of bits required to represent such runs of pixels.

12. The method of claim 10, wherein the inter-frame redundancies are reduced by encoding runs of similar pixels having reduced color fidelity common to more than one frame in each group of frames.

13. The method of claim 10, further comprising decoding the digital video file by reproducing each of the frames from the reference pixels for each such frame.

14. A method, comprising decoding an encoded digital video file by reconstructing a table of encoded pixel values into pixel color parameters using a set of reference pixel colors, scaling up the pixel color parameters by a scaling factor associated with the reference pixel colors and presenting one or more frames composed of reconstructed and scaled up pixels via a display device.

15. The method of claim 14, wherein the reference pixel colors are selected from a set of reference pixels transmitted with the encoded digital video file.

16. The method of claim 15, wherein the reference pixels apply on a frame-by-frame basis to the encoded digital video file.

17. The method of claim 15, wherein the reference pixels apply to all frames in the encoded digital video file.

18. The method of claim 14, comprising prior to decoding, creating the encoded digital video file by mapping multi-dimensional pixel parameters of a raw video file to fewer dimensional parameters so as to create the table of encoded pixel values in which the pixel values are represented by encoded counterparts and in which redundancies between the encoded counterpart values are reduced.

19. The method of claim 18, wherein the mapping is performed by comparing each pixel of the raw video file to a reference color pallet and selecting a closest matching encoded color value therefrom.

20. The method of claim 19, wherein the reference color pallet is created on a frame-by-frame basis from the raw video file.
